(19) United States
(12) Patent Application Publication
(10) Pub. No.: US 2003/0090897 A1
(43) Pub. Date: May 15, 2003

(54) Light emitting device

(76) Inventor: Chin-Lai Su, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/986,840

(22) Filed: Nov. 13, 2001

(51) Int. Cl. F21L 4/00

(52) U.S. Cl. 362/186; 362/234; 362/235; 362/101; 362/124; 362/158; 362/806

(57) ABSTRACT

A light emitting device includes a housing, a circuit board and a base. The circuit board is hidden in the base with lower end of two conductive wires thereof sticking out from the bottom of the base. A battery, and a lamp are fitted onto the circuit board. The housing is made of materials that allow light to pass through, and has blocks of ornamental objects received in it. The base is closely fitted into a lower opening of the housing with the lower end of the conductive wires facing outwards. When the light emitting device is put into a conductive drink, the drink will get into contact with the lower ends of the conductive wires so as to complete the circuit for the lamps to send out light through the housing.

### BACKGROUND OF THE INVENTION

The present invention relates to a light emitting device, and more particularly, to one, of which the circuit becomes complete to cause the LED (light emitting diode) to send out light when the device is put into conductive liquids such as soft drinks; thus, the device can be ornamental.

In a party or restaurant, there are various delicious foods and drinks provided for people to enjoy. In addition, more and more attention is paid to how the foods and drinks can be prepared with pleasant and attractive look as well, such that more joyous atmosphere can be added to the occasion. To make drinks look more pleasant and attractive, the drinks can be held in glasses of various colors and shapes, and ice, stirring sticks, and ornamental fruits can be put into the glasses.

However, these ornaments still seem monotonous, especially when people have been using them for many times.

### SUMMARY OF THE INVENTION

Therefore, it is a main object of the present invention to provide an ornamental light emitting device, of which the LED can send out light when the device is put into a conductive drink held in a glass such that the drink and the glass can look more pleasant and attractive.

The light emitting device of the present invention includes a housing, a circuit board, and a base. The housing is made of materials that allow light to travel through. The circuit board including a board part, electric lamps fitted on the board part, a battery, and two conductive wires electrically connected to both the lamp and the battery. The circuit board is received in the base with outer ends of the wires sticking out from the bottom of the base, and with the lamps sticking up on the base. The base received in the housing with the bottom thereof sealing up a lower opening of the housing. Thus when the device is put into a conductive liquid, such as drinks, the conductive liquid will get into contact with the outer ends of the conductive wires so as to complete the circuit of the circuit board for the lamps to send out light through the housing.

### BRIEF DESCRIPTION OF THE DRAWINGS

This invention will be better understood by referring to the accompanying drawings, wherein:

FIG. 1 is an exploded perspective view of the light emitting device of the first embodiment of the present invention.

FIG. 2 is a cross-sectional view of the light emitting device in FIG. 1.

FIG. 3 is a view illustrating the use of the light emitting device in FIG. 1.

FIG. 4 is a cross-sectional view of the light emitting device of the second embodiment of the present invention, taking the form of a drink stirring stick,

FIG. 5 is a front view of the light emitting device of the second embodiment of the present invention,

FIG. 6 is a view illustrating the use of the light emitting device in FIG. 4.

FIG. 7 is a plan view of the third embodiment of the present invention.

FIG. 8 is a plan view of the fourth embodiment of the present invention.

### DETAILED DESCRIPTION OF THE PREFERRED EMBODIMENTS

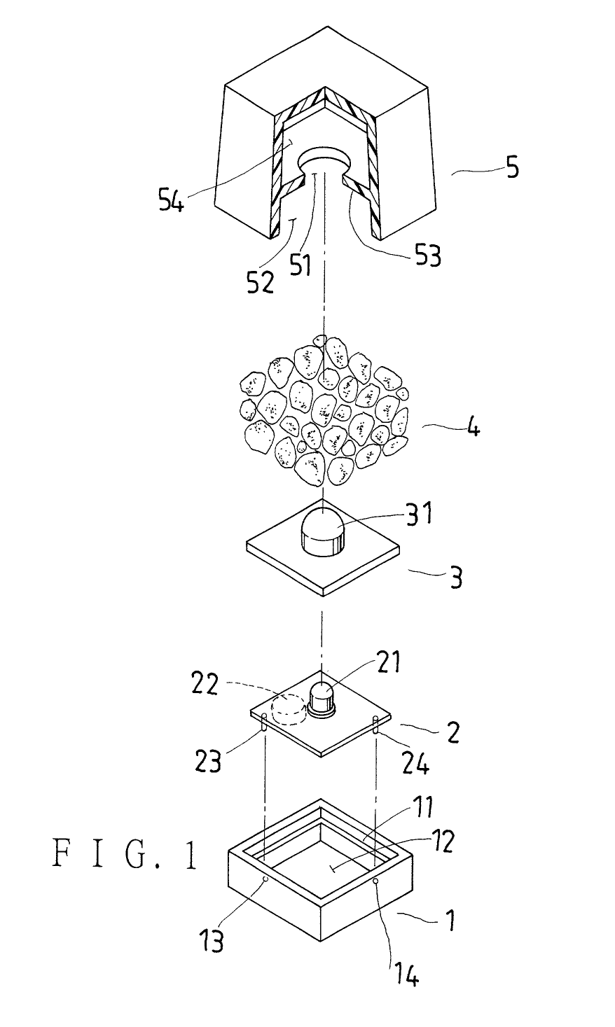

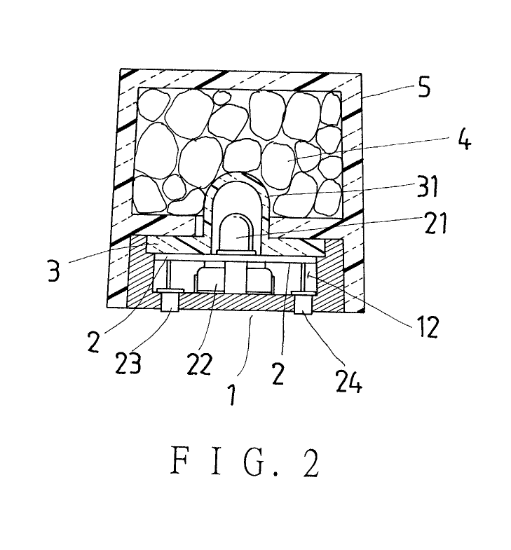

Referring to FIGS. 1 and 2, a light emitting device according to the first embodiment of the present invention includes a base 1, a circuit board 2, a covering 3, ornamental object 4 and a housing 5.

The base 1 has a surrounding wall and a bottom (not numbered). The surrounding wall defines a holding room 12, and has a recess 11 on the upper parts of inner sides thereof. The bottom has two through holes 13 and 14. The circuit board 2 includes a board part (not numbered), an electric lamp 21 held on the board part, a battery 22, and conductive wires 23 and 24 connected to both the lamp 21 and the battery; the lower ends of the conductive wires 23 and 24 stick out from the lower side of the board part. The covering 3 includes a board part (not numbered), a hollow protrusion 31, which is formed on the upper side of the covering board part, and has a lower opening; the covering 3 made of transparent materials or semitransparent materials of various colors. The ornamental objects 4 are light in weight, and can be made of transparent or semitransparent materials, such as magic crystals, which look like jellies, and are blocks of irregular shapes. The housing 5 can be transparent or semitransparent, and has a top (not numbered), a surrounding wall, a separating board 53 connected to the inner side of the wall, an inner receiving room 54 defined by the top, the wall, and the separating board 53, and has an outer receiving room 52 under the separating board 53; the separating board 53 has a hole 51 for the rooms 52 and 54 to communicate with each other; the housing 5 is preferably shaped to be like an ice cube.

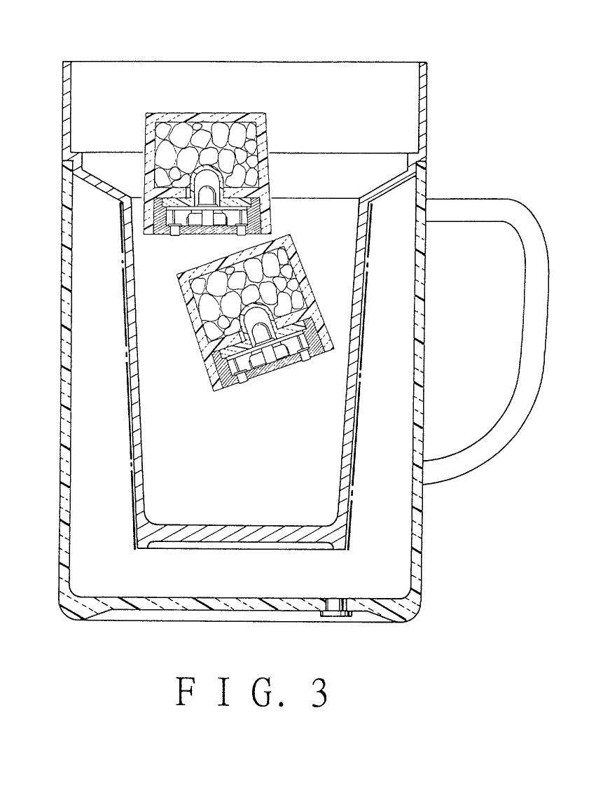

In combination, the ornamental objects 4 are contained in the inner receiving room 54 of the housing 5. The circuit board 2 is placed in the holding room 12 with the lower ends of the wires 23, and 24 passing through the holes 13, and 14 respectively. The covering 3 is placed in the holding room 12 with the edge of the board part thereof being closely fitted onto the recess 11 for the same to cover the board part of the circuit board 2, and with the hollow protrusion 31 mounted on the lamp 21. Finally, the base 1, and the covering 3 together are fitted into the outer receiving room 52 of the housing 5 with the hollow protrusion 31 passing through the hole 51 of the separating board 53; adhesive is applied between the wall of the base 1 and the housing 5 to make both stick together. Referring to FIG. 3, when the light emitting device is put into a glass holding conductive drinks, the drinks will get into contact with the lower ends of the wires 23 and 24 to complete the circuit; thus, the electric lamp 21 send out light with the electricity of the battery 22 through the covering 3, the ornamental objects 4 and the housing 5. The electric lamp 21 can be an LED or an ordinary bulb.

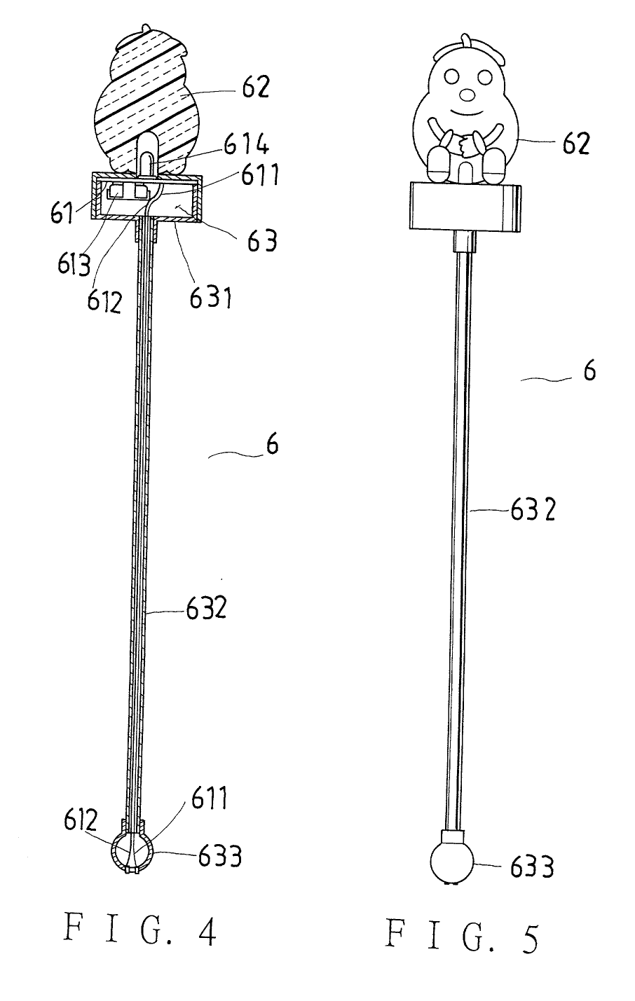

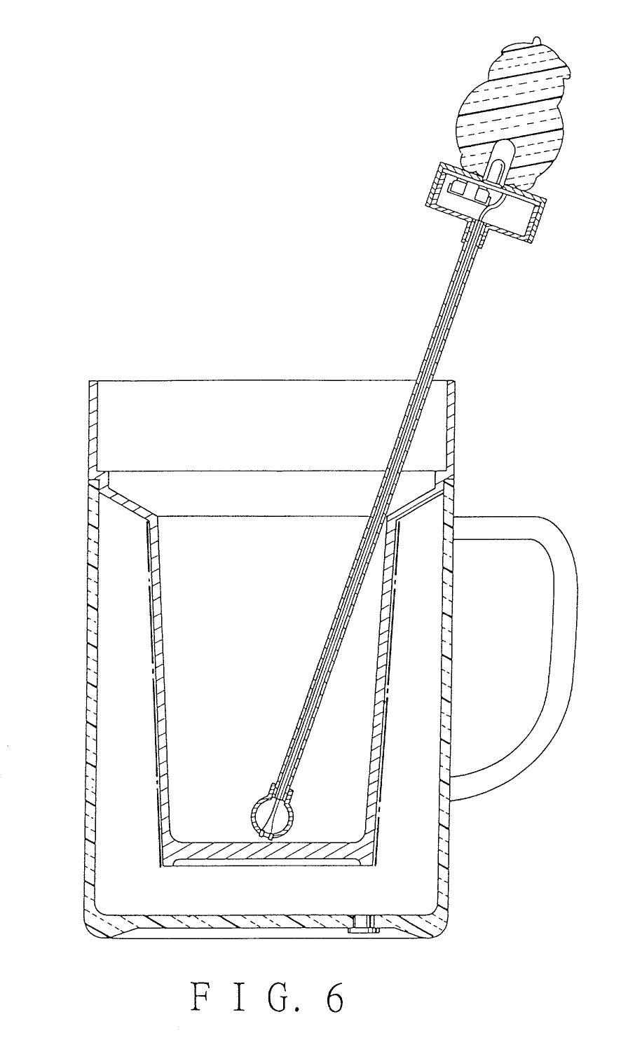

Referring to FIGS. 4, 5 and 6, a light emitting device 6 of the second embodiment takes the form of a drink stirring stick, and includes an ornamental main body 62, a holding room 63, a circuit board 61 with a battery 613, and an electric lamp 614 and a tube 632. The ornamental main body 62 can be provided with a shape and appearance pleasant to look at. The circuit board 61 is placed in the holding room 63 with the lamp 614 passing into the main body 62. The ornamental main body 62 is of course made of transparent or semitransparent materials. A base 631 is connected to the tube 632, and firmly placed on the lower opening of the holding room 63, and conductive wires 611 and 612 of the circuit board 61 are passed through the tube 632 to stick out from a lower end member 633 connected to the lower end of the tube 632. Thus, referring to FIG. 6, when the lower end member 633 is placed into drinks, which are conductive, the lamp 614 can emit light through the ornamental main body 62.

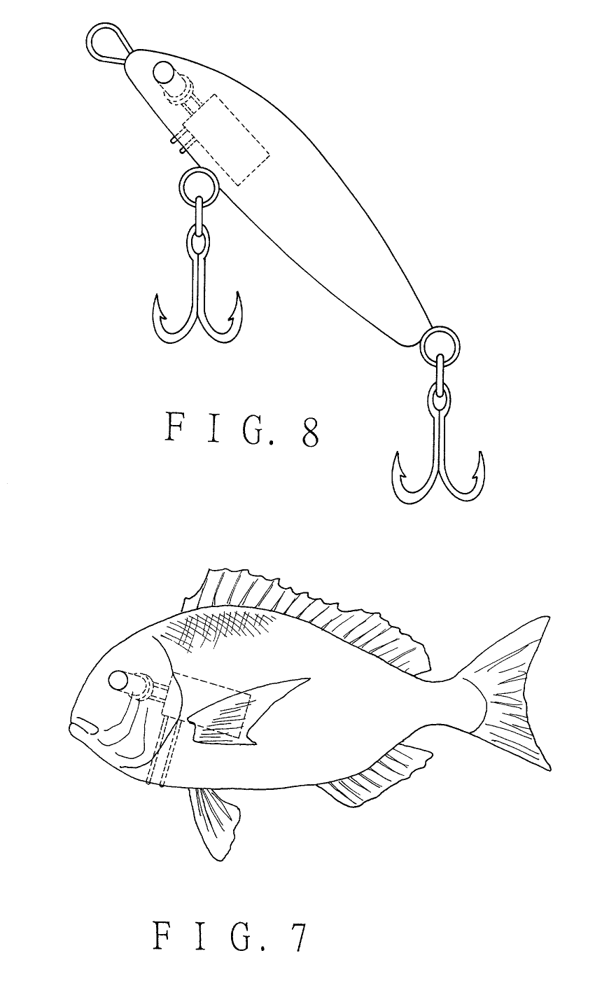

Referring to FIG. 7, a circuit board with an electric lamp and conductive wires of the kind can be hidden in various shaped transparent or semitransparent objects, such as artificial marine animals and fake baits, with the outer ends of the wires sticking out from the objects. Thus, the artificial marine animals can send out light to become ornaments when they are put into conductive liquids, while the fake baits can emit light to attract fish when they are used in fishing.

From the above description, the light emitting devices of the present invention have better effects in making a drink look more attractive than conventional methods.

What is claimed is:

1. A light emitting device, comprising
a housing made of materials allowing light to travel through;
a circuit board including a board part, and a plurality of electric lamps fitted on said board part; said circuit board having a battery, and two conductive wires electrically connected to both said lamp and said battery; said circuit board being hidden in said housing with outer ends of said conductive wires sticking out from said housing for a conductive liquid to get into contact with so as to complete said circuit board for said lamp to send out light when said housing is placed into said liquid.

2. The light emitting device as claimed in claim 1, wherein said housing is made to have a shape like an ice cube.

3. The light emitting device as claimed in claim 1, wherein said housing is made to have a shape of a marine animal.

4. The light emitting device as claimed in claim 1, wherein said electric lamps are light emitting diodes.

5. The light emitting device as claimed in claim 1 wherein said circuit board is received in a base with said outer ends of said conductive wires being passed through a bottom of said base, and is covered with a transparent covering, and said housing includes an inner, and an outer receiving rooms separated by an intermediate separating board having a hole; said housing receiving ornamental objects in said inner receiving room; said base together with said covering being fitted into said outer receiving room of said housing with a part of said covering mounted on said electric lamps being passed through said hole of said separating board of said housing.

6. The light emitting device as claimed in claim 1, wherein said housing is provided with a transparent ornamental body on an upper side, and a stirring tube connected to a lower side thereof; said conductive wires being passed through said tube with said outer ends thereof sticking out from a lower end member connected to a lower end of said tube.

7. The light emitting device as claimed in claim 1, wherein said housing is shaped like a bait.
